(19) United States
(12) Patent Application Publication
(10) Pub. No.: US 2008/0105443 A1
(43) Pub. Date: May 8, 2008

(54) Fire And Explosion Protection Method In A High-Bay Warehouse In Which Chemical Hazardous Materials Are Stored, And Fire/Explosion-Protected High-Bay Warehouse

(75) Inventors: Diethard Molz, Munster (DE); Ludger Leusbrock, Steinfurt (DE); Reinhard Drewes, Munster (DE); Adreas Treydte, Drensteinfurt (DE); Peter Bachhausen, Nottuln (DE)

Correspondence Address: BASF CORPORATION;Patent Department, 1609 BIDDLE AVENUE, MAIN BUILDING, WYANDOTTE, MI, 48192, US

(73) Assignee: BASF Coatings Aktiengesellschaft, Munster (DE)

(21) Appl. No.: 10/547,690

(22) PCT Filed: Mar. 4, 2004
(86) PCT No.: PCT/EP04/02168

§ 371 Date: Mar. 27, 2007

(30) Foreign Application Priority Data
Mar. 11, 2003 (DE) 10310439.9

(51) Int. Cl. A62C 3/00; A62C 2/00; A62C 3/06

(52) U.S. Cl. 169/45; 169/54; 169/56

(57) ABSTRACT

Method for fire and explosion protection in a high-bay warehouse for hazardous chemical substances and, in particular, for Class AI and B VbF [Order on combustible liquids] substances, by
reducing the proportion by volume of oxygen in the atmosphere within the warehouse by permanent inertization by means of a barrier gas, in particular nitrogen, to a value of between 12.9 and 13.4% by volume,
monitoring of the proportion by volume of oxygen in the atmosphere by means of oxygen detectors,
ensuring a homogeneous distribution of the oxygen-reduced atmosphere in the warehouse,
monitoring of the proportion by volume of solvent in the atmosphere by means of solvent detectors,
circulation of the atmosphere in the warehouse via at least one air circulation system,
very large-scale avoidance of the use of ignition sources,
removal of gaseous substances from the atmosphere in the warehouse, and
avoiding concentration of dusts by the installation of filters in the at least one air circulation system,
   and a corresponding high-bay warehouse.

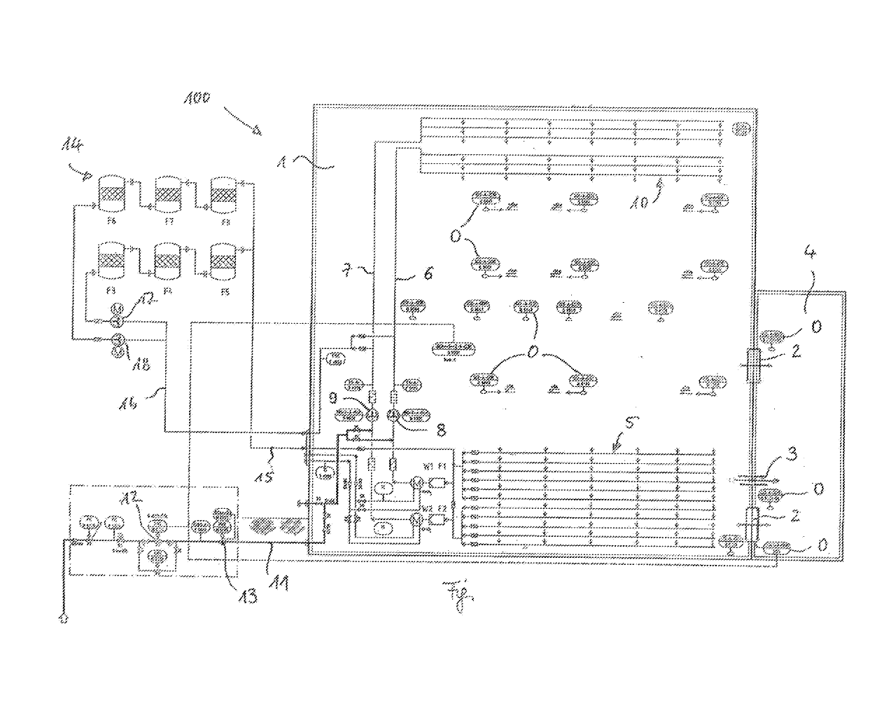

The invention relates to a method for fire and explosion protection in a high-bay warehouse for hazardous chemical substances and, in particular, highly flammable substances, by means of an oxygen-reduced atmosphere, and to a corresponding fire and explosion-protected high-bay warehouse.

Protection against fires in warehouses used for combustible liquids is normally based on fighting a fire that has occurred by means of conventional fire extinguishing devices such as sprinkler, heavy-foam and gas extinguishing systems, as well as fire walls including fire identification and retention of water used for extinguishing.

The expression fire protection covers all measures aimed at preventing and fighting fire, and in particular to measures which are taken to protect personnel against fires or the consequences of fires (for example smoke gases). In order to achieve these protection aims, physical systems must be procured such that the creation of a fire and the propagation of fire and smoke are protected against, and such that, in the event of a fire, it is possible to rescue people and animals as well as to carry out effective extinguishing work. A fire protection concept thus includes a large number of measures, which provide the preconditions for successful fire fighting by the fire service, and which restrict the damage.

Suitable measures are, inter alia:
a) physical measures (formation of fire sections by means of fire-resistant room or space boundaries, as well as fire-constraining and/or fire-resistant components (for example doors), designing buildings with suitable escape and rescue routes),
b) technical measures (provision of suitable extinguishants, which may be initiated if necessary by means of automatic extinguishing systems (for example sprinkler systems), smoke and heat extraction systems), and
c) organizational measures (carrying out fire presentations, organization of alarm and hazard defense plans, holding practices, the instruction of personnel, the provision of fire safety posts at work and/or events involving a particular fire risk for people and equipment)
   (see Römpp Chemistry Dictionary—CDROM Version 2.0 Stuttgart/New York: Georg Thieme Verlag 1999).

Normally, conventional fire extinguishing facilities such as sprinkler and gas extinguishing systems as well as fire walls are used for protection against fires in warehouses. Disadvantages in this case include both the high physical and investment costs and the destruction and/or damage to the items being stored by the fire itself, by the extinguishing process or even by false alarms. Furthermore, the size of modern warehouses (>20000 m³) require that fire protection be completely rethought, since conventional fire protection systems would not be economic.

One relatively recent method for fire prevention is to reduce the oxygen, which is required for a fire to be created and propagate, in the atmosphere of the warehouse (permanent inertization). In this case, the oxygen concentration is reduced to a level at which it is no longer possible for a fire to be created or to propagate, owing to the shortage of oxygen. The damage caused by a fire, for example damage caused by the extinguishing water, is thus avoided. Furthermore, there is no need for the high investment levels required for the construction and operation of conventional extinguishing systems.

However, explosion protection must also be ensured for the storage of hazardous substances, in particular for those in Classes AI and B of the VbF (Verodnung über Anlagen zur Lagerung brennbarer Flüsigkeiten [Order governing systems for the storage of combustible liquids]).

Explosion protection covers all the measures for protection against dangers caused by explosions and these are subdivided, for example, into:
a) measures which prevent or restrict the formation of dangerous explosive atmospheres,
b) measures which prevent the ignition of dangerous explosive atmospheres, and
c) measures which restrict the effects of an explosion to a permissible level.

Measures according to a) include, for example,
the replacement of the combustible substance by a substance which is not combustible,
use of substances with a flashpoint above the highest operating temperature,
restriction to the concentration of the vapor-gas-mist-dust/air mixture,
inertization in the interior of the apparatus,
frequent and comprehensive removal of dust deposits,
natural and artificial ventilation measures and
monitoring of the concentrations in the vicinity of apparatuses.

Measures according to b) cover the avoidance of all ignition source types, such as:
open fire,
smoking, welding, cutting work using equipment which results in sparks,
use of explosion-protected appliances (for example encapsulated motors),
use of low-spark tools,
prevention of electrostatic charging (by grounding, conductive appliances, conductive clothing, safe working techniques), and
compliance with the maximum surface temperatures (for example temperature monitoring for protection of drive motors which run hot).

Measures according to c) include, for example:
systems and apparatuses constructed to be resistant to explosion pressures and explosion surge pressures
explosion pressure relief
explosion suppression
restriction of explosions to subareas of apparatuses.

However, the physical measures for explosion protection which have been mentioned, in particular those according to a) and c), for industrial warehouses can no longer be implemented without disadvantages beyond a certain size, and in some cases cannot be combined with the measures for fire protection. For example, although it is technically feasible to subdivide a high-bay warehouse into fire sections, this complicates the servers, however, and the use of additional fire doors etc. represents further sources of failure. Furthermore, for example, it is difficult to reconcile inertization using nitrogen in a sealed building with ventilation at the same time in order to prevent the accumulation of solvents, dust or smoke gas in the event of fire.

The document Process Technology 36 (2002) No. 3 discloses a high-bay warehouse for hazardous substances, in which the oxygen concentration in the atmosphere in the warehouse area is reduced in order to avoid fires. The oxygen concentration in the warehouse area is reduced to a value below 15% by volume by feeding in nitrogen. This value is maintained by suitable monitoring and readjustment, and/or stopping the supply, of nitrogen. This is possible since this relates to a warehouse which is operated completely automatically, so that no personnel are continuously in the warehouse area. In order to comply with the building regulations, the warehouse is subdivided into two separate fire sections by means of a fire wall. However, this fire wall is provided with a passage for a rack server, in order to allow completely automatic operation. However, this is dependent on the use of a fire protection door, which is extremely large and thus costly since the warehouse has a size of 67000 m³. However, the document contains nothing with regard to explosion protection.

The document Gas AktuelI [Gas News] 56 likewise discloses warehouses of this generic type with a reduced oxygen atmosphere in which, for example, deep-frozen goods are stored at −28° C., in an atmosphere with 17% by volume of oxygen. The value of 17% by volume of oxygen is sufficient for fire protection at this temperature, and allows the warehouse to be entered without breathing protection. With a concentration of 11.3% by volume, this would be possible safely for only one hour, according to the document. For other stored goods at room temperature, it is assumed that most substances will burn only with difficulty at an oxygen concentration of about 15% by volume. At 12% by volume, most substances will not burn. The document mentions, in a general form, that permanent inertization with nitrogen can in some circumstances replace explosion protection. The document merely mentions that ignition (for explosion) is no longer possible below a certain oxygen concentration. The precise oxygen concentration and specific measures for explosion protection are not described.

Experiments with highly combustible substances (VbF Class AI and B substances), have shown that easily combustible, organic solvents with a flash point below 21° C. (VbF Class AI and B substances) cannot be ignited and cannot continue to burn when stored in an oxygen-reduced atmosphere with 13% by volume of oxygen.

The high proportion (87%) of inert gas to produce this oxygen reduction is not, however, sufficient to preclude the risk of ignition of an explosive mixture.

Safe explosion protection at room temperature for solvents such as these is provided only with an oxygen concentration of much less than 10% by volume. Although it is technically feasible to produce and maintain an atmosphere such as this, a warehouse such as this cannot be entered, however, without breathing protection, since this low oxygen concentration represents a lethal danger. Maintenance and/or repair and/or inspection procedures which are required regularly thus cannot be carried out, or can be carried out only with a high level of complexity. The oxygen content of the atmosphere must be increased in order to carry out lengthy tasks, as a result of which the warehouse cannot be operated in this time period, or can be operated only with a high risk level. The oxygen content of the atmosphere must subsequently be reduced once again. A procedure such as this is not acceptable, however, due to the high costs and time penalty, particularly in the case of large warehouses, as described above.

The object of the present invention is thus to provide a method both for safe fire and explosion protection in a high-bay warehouse for hazardous chemical substances, in particular Class AI and B VbF substances, and to provide a corresponding high-bay warehouse, in which an oxygen-reduced atmosphere is used and in which case, however, the warehouse can still be entered without breathing protection and furthermore has a structurally simple design, that is to say, for example, can be designed without fire sections and without special fire protection cladding.

This object is achieved by the method according to the invention described in claim 1, and by the high-bay warehouse according to the invention described in claim 18.

Surprisingly, it has been found that fire and explosion protection in a high-bay warehouse for hazardous chemical substances and, in particular, Class AI and B VbF substances, can be achieved by:
reducing the proportion by volume of oxygen in the atmosphere within the warehouse by partial permanent inertization by means of a barrier gas, in particular nitrogen, preferably to a value of between 12.9 and 13.4% by volume,
monitoring of the proportion by volume of oxygen in the atmosphere, for example by means of oxygen detectors,
ensuring a homogeneous distribution of the oxygen-reduced atmosphere in the warehouse,
monitoring of the proportion by volume of solvent in the atmosphere, for example by means of solvent detectors,
circulation of the atmosphere in the warehouse, for example by means of at least one air circulation system,
very large-scale avoidance of the use of ignition sources,
removal of gaseous substances from the atmosphere in the warehouse, for example by means of a cleaning system, and
avoiding concentration of dusts, for example by the installation of filters in the at least one air circulation system.

Fire and explosion protection are also achieved in the high-bay warehouse according to the invention for hazardous chemical substances and, in particular, Class AI and B VbF substances, which has
at least one device, for example an air circulation system, for reducing the proportion by volume of oxygen in the atmosphere of the warehouse by feeding it a barrier gas, in particular nitrogen, preferably at a value of between 12.9 and 13.4% by volume,
at least one monitoring device for monitoring the proportion by volume of oxygen in the atmosphere, for example by means of oxygen detectors distributed uniformly in the warehouse,
at least one air circulation system, in order to ensure homogeneous distribution of the oxygen-reduced atmosphere in the warehouse,
at least one further monitoring device for monitoring the proportion by volume of solvent in the atmosphere by means of solvent detectors,
at least one cleaning system for removing gaseous substances from the atmosphere in the warehouse, and
filters in the air circulation system in order to avoid the concentration of dusts.

Although the reduction in the proportion by volume of oxygen in the atmosphere within the warehouse is achieved by partial permanent inertization by means of a barrier gas, in particular nitrogen, preferably only to a value of between 12.9 and 13.4% by volume, safe fire and explosion protection can nevertheless be ensured, since the interaction of all these measures results in a synergistic effect.

Furthermore, the reduction according to the invention of the proportion by volume of oxygen, in particular to a value of between 12.9 and 13.4% by volume, allows the warehouse to be entered at any time, without any need for breathing protection.

Furthermore, the interaction according to the invention of all the measures means that there is no need whatsoever for fire sections, thus simplifying construction and control, in particular automatic control of the high-bay warehouse.

When the oxygen content in the air is reduced using nitrogen, the fire protection effect is based on reducing the proportion of oxygen in the warehouse atmosphere sufficiently that a fire becomes impossible. The high-bay warehouse is therefore operated with a residual oxygen atmosphere of approximately 13% by volume. In these conditions, fires cannot develop in the high-bay warehouse, and a fire that has been started cannot propagate. The residual oxygen concentration must then be distributed to comply with the required values in every area of the high-bay warehouse, that is to say homogeneously.

The warehouse atmosphere is considered to be homogeneously distributed when
from the fire protection point of view, the residual oxygen content is below 13.2% by volume everywhere, and
from the personnel protection point of view, the oxygen content is not less than 12.9% by volume anywhere in the warehouse.

The expression long-term, permanent fire protection may be used when the warehouse atmosphere has this homogeneity everywhere.

Local concentrations of oxygen, as well as layers of concentration from the floor area to the warehouse ceiling, can be prevented if the air is circulated continuously by means of an air circulation system.

The air circulation system is designed such that, theoretically, the entire warehouse atmosphere is circulated once at least every 2½ hours (air circulation rate at least 0.4). Two air circulation systems which are integrated in the high-bay warehouse ensure that the air in the warehouse is distributed homogeneously. The supply air is distributed uniformly under the warehouse ceiling, and is sucked in again via extraction channels in the floor area. Any concentrations of solvent vapors that occur in the floor area are extracted and diluted.

If the volume of the high-bay warehouse is, for example, approximately 31, 45, 117 m³ (H, W, L), corresponding to a spatial volume of approximately 160000 m³, then 65000 m³ of air must be circulated per hour, with the air circulation rate being 0.4×160000 m³/h.

During operation of the high-bay warehouse, the rack servers also mix the warehouse atmosphere as a result of their vertical and horizontal movements.

The pure nitrogen is mixed with the warehouse air on the pressure side in the air circulation channels, with the mixture ratio of pure nitrogen to the oxygen-reduced atmosphere in this case being approximately 1/100.

If the ventilation fails, the addition of nitrogen is ended immediately, in order to avoid local excess concentrations (personnel protection). Experiments in a building of the same type to a scale of 1:1 000 have made it possible to show that it takes several hours before the fire protection is lost in the event of an interruption in the nitrogen supply. Sufficient time is therefore available, without any need to immediately interrupt the procedures for placing goods into the warehouse, and removing them from it.

For quality reasons, the product temperature in the high-bay warehouse must be between +5 and +30° C. If the warehouse air temperature is kept in this temperature range, it can be assumed that the product will not assume any different temperature values, either. If, despite this, it can be foreseen that the air temperature range in the high-bay warehouse will be infringed in either direction, heating or cooling appliances can be connected, which can supply or carry away the energies by means of heat exchanges that are integrated in the air circulation system.

The room temperature is measured at points where the highest temperature gradients can be expected, that is to say under the roof and on the south-facing wall of the high-bay warehouse. By way of example, eight measurement points with resistance thermometers are provided for this purpose. The display is provided in the building control system.

An alarm is produced if any limit values are exceeded. The room temperature must always be between 5 and 30° C. If these values are exceeded, heating energy or cooling energy can be introduced from the outside via heat exchangers which are built into the air circulation channels. Mobile energy units can be fitted externally to the high-bay warehouse for this purpose, and can be connected to the external wall via couplings and, internally, pipelines that are laid to the heat exchangers.

The oxygen-reduced atmosphere must be very largely sealed from the atmosphere surrounding it with the normal oxygen concentration of 20.9% by volume of oxygen, in order to keep equalization processes from the outside to the inside, and in the opposite direction, as small as possible, that is to say the high-bay warehouse must be sealed as well as possible.

Equalization processes can take place:
by convection via openings as a result of pressure differences between the external environment and the high-bay warehouse,
by diffusion in the air or through materials, caused by the different proportions of oxygen and nitrogen, and the concentration gradients associated with them (partial pressure gradient).

Furthermore, higher temperatures that occur locally increase the partial pressure, and hence the respective concentration gradient.

The sealing of the building is thus also dependent on the weather conditions. The air pressure, wind strength, temperature and solar radiation exert an influence on the atmosphere in the high-bay warehouse.

The influence of the external conditions on the shell of the building can be tested using standardized methods. A constant overpressure or reduced pressure is applied in the building, and the leakage rate resulting from this is calculated. The magnitude of the leakage rate provides an indication of the minimum amount of nitrogen to be resupplied to the warehouse. It has been possible to make a sensible estimate of this minimum amount of nitrogen by experiments on a model hall, to a length scale of 1:10.

The physical design of the airtight building shell includes, inter alia:
flooring and a building plinth with an HDPE plastic ceiling web inserted,
wall surfaces in the region up to a building height of 10 m composed of noncombustible steel plate sandwich elements with Rockwool insulation (melting point greater than 1000° C.). All element joints and joints to the building plinth have an airtight plastic sealing web bonded over them, and are mechanically protected. Wall surfaces in the building height range between 10 m and 30 m as a noncombustible double-shell cast glass structure (Profilit or Reglit system) with completely filled glass joints composed of elastic jointing material. All element joints and joints to steel sheet sandwich elements have airtight plastic sealing web bonded over them, and are mechanically protected.
Door composed of steel sheet with circumferential, double seals and door apertures closed in an airtight manner. Joints to other elements as described above.
A roof surface composed of noncombustible trapezoidal steel plates with rockwool insulation (melting point greater than 1000° C.) resting on them, bonded over with plastic sealing web, welded such that it is airtight, and mechanically protected.

The reliability of the compartmentalization in the fire wall for the high-bay warehouse is of particular importance. The only apertures in this wall are therefore those which are absolutely essential.

These are: electrical power, measurement and control lines, material airlocks and an internal connecting door.

The ventilation technology for the air circulation in the high-bay warehouse is located on a platform in the high-bay warehouse itself, so that there is no need for the fire wall to be penetrated for this purpose.

However, procedures for placing goods in store and removing them from store are associated with the ingress of oxygen into the high-bay warehouse:
1. Directly through the door openings owing to the pressure differences between the consignment zone and the high-bay warehouse, and/or as a result of air turbulence resulting from the transportation process in the direction of the high-bay warehouse. Furthermore, high diffusion rates can be expected due to partial pressure differences between the high-bay warehouse and the consignment zone. Residual oxygen levels of more than 19% by volume of oxygen are ensured throughout the consignment zone.
2. Via air introduced in packaging. The oxygen will diffuse out owing to the partial pressure gradient between the enclosed air volume in the packaging and the warehouse atmosphere. In this context, the term packaging should be understood as meaning packaging in the form of cartons, wound tin plate casings, and the like.

The sum of the oxygen introduced in all the procedures for placing goods in the warehouse and removing them can be added up, with the assumptions that a constant oxygen concentration is produced in the airlocks over a period of time, which will be between the oxygen concentration in the consignment zone of 20.9% by volume and 13% by volume, and that a certain airlock volume will be introduced into the high-bay warehouse during each transportation process. The active time of operation is also used as a basis for the calculation.

The atmosphere in the high-bay warehouse is thus influenced via:
a) the building by weather conditions such as air pressure, wind strength, temperature, solar radiation
b) the number of airlock procedures
c) the number of load carriers introduced, for example cartons.

The amount of nitrogen or nitrogen/air mixture that is supplied is thus not constant but varies depending on the external conditions and the way in which the warehouse is operated. During peak utilization of the high-bay warehouse, a greater number of airlock activities can be expected, along with a corresponding increase in the amount of oxygen introduced. These influences become noticeable only gradually in the warehouse atmosphere, owing to the large warehouse area volume.

Overall, during operation of the high-bay warehouse quoted by way of example above, and depending on its utilization level, approximately 300 to 1200 Nm³/h of pure nitrogen are required continuously in order to compensate for the oxygen that is introduced.

It is feasible to introduce the nitrogen at various points in the high-bay warehouse. For safety at work reasons, the nitrogen component must not exceed the limit value to be complied with.

The pure, or already premixed nitrogen can be added as follows:
directly into the air channel, where intensive mixing with the warehouse atmosphere is achieved,
at points in the building where an increased oxygen introduction/loss of nitrogen can be expected, for example in the vicinity of the airlocks,
in the lower area of the hall, in order to counteract concentration layers from the floor to the hall ceiling,
adjacent to the outer walls, in order to compensate for increased oxygen introduction resulting from the partial pressure gradient that exists.

Oxygen enrichment is kept within the permissible tolerances at every point in the high-bay warehouse. It must be possible to compensate quickly for any oxygen that is introduced. Fast identification of discrepancies from the nominal state is necessary for this purpose.

Measurement value sensors are fitted distributed uniformly in the high-bay warehouse in order to check the homogeneity of the oxygen-reduced atmosphere in the high-bay warehouse.

The oxygen content is in each case extracted by vertically laid induction tubes, which are attached to the shelves. The induction tubes have two or more induction openings, distributed at different heights.

The measurement process is carried out on a redundant basis, via two parallel sensor heads. One sensor head measures the oxygen content permanently, while the other sensor is switched on at defined time intervals and compares the two measured values for any discrepancy.

If a sensor becomes defective, the defect is identified from the comparison of the two sensors, and a defect is signaled. Failure of more than two sensors leads to the system being switched off.

In a preferred design variant, paramagnetic O₂ measurement devices are used as sensors, where 16 measurement points are switched serially, that is, after one another, onto one analysis device. The analyzed air is pre-inducted. The elapsed time of an O₂ measurement device at the analyzer amounts to 30 s. The measurement value is updated every eight minutes.

The calibration of the analysis devices preferably occurs with highly accurate text gases, automatically once a day.

In a high-bay warehouse of the size described here in more detail, 38 aspiration openings are arranged to cover the area, and are distributed across three planes.

In areas where the presence of persons is to be expected frequently, such as, for example, at the entrance or at a switching cabinet, additional, preferably 10 induction openings are provided in the particularly preferred variant.

The O2 analysis devices are preferably installed outside the high-bay warehouse, for instance, in a switching cabinet.

Preferably, the analyzers have a common reference point in the area of the entry door of the high-bay warehouse. This refers to an arrangement in which one O₂ measurement point of each analysis device measures the same measurement location. Then, a two-out-of-three evaluation is performed in which at least two measurement values must lie within a defined range. If the measurement values lie outside this range, this is considered an indication of a faulty measurement, and these measurement values are ignored.

In the area of the airlocks to the high-bay warehouse, at least one electro-chemical O₂ measurement device can be provided whose alarm threshold is preferably <=19 vol %.

The control of the oxygen concentration in the high-bay warehouse occurs in that, depending on the measured oxygen concentration, nitrogen is fed into the high-bay warehouse. For this purpose, the amount of nitrogen is adjusted continuously, using a set valve, depending on the analog output signal of a PID controller.

The controller is preferably implemented as a software module. The arithmetic mean of 48 individual measurements of the O₂ concentration is used as the control variable. The reference variable is fixed, and is set to 13.1 vol. % O₂.

The analog measurement signals of the analysis devices are also monitored for exceeding or falling below the alarm thresholds mentioned above. For this, each O₂ measurement point is monitored and accordingly evaluated and set for alarm. The arithmetic mean is not used for the alarm function.

If the value falls below the alarm threshold of 12.9 vol. % of O₂, in addition to the alarm, the personnel access doors to the high-bay warehouse is automatically locked, and check valves in a nitrogen feed line are closed through direct control by a stored program control (SPC).

A fail-safe SPC according to the European standard IEC 61511 is used.

The alarm function of the personnel protection boundary, the closing of the nitrogen feed, and the locking of the access door are implemented as a class A protection function.

In the case of a complete power failure, no ignition sources are present in the warehouse, and the access is locked, and the personnel in the warehouse is summoned via radio to leave the warehouse immediately.

The control of the nitrogen valves is turned off, the valves close and interrupt the nitrogen feed.

No measurement of the O₂ concentration in the high-bay warehouse occurs.

After at most 30 minutes, the power supply resumes from an emergency power supply, for instance of the site's fire brigade, via an external feed. Likewise, the O₂ measurements and the O₂ control are resumed.

After resumption of the power supply of the high-bay storage, the operation is only resumed when the measurement systems have reached their normal state, the measurement values of the quantities to be measured lie within approved ranges, and the pending alarms have been resolved completely by the personnel. An automatic restart is prevented.

The analysis system for the oxygen can, in addition, be equipped with an infrared gas filter correlation sensor for carbon monoxide. The measurement range is preferably adjusted to 0 to 100 ppm CO, so that carbon monoxide traces are safely detected. The monitoring for CO occurs over the entire area in the same way as the oxygen measurement described above. If a limit is exceeded, an alarm occurs in the building control system.

The measurement serving for the protection of personnel of the high-bay warehouse that is normally operated without personnel is carried out locally at points at which people enter the high-bay warehouse and can be directly at risk:
at the access door,
and at points at which pure nitrogen can emerge.

The control error there is, for example, ±0.125% by volume. A small control error is desirable for personnel protection reasons.

Illuminated display panels adjacent to the access doors indicate the reduced oxygen content in the high-bay warehouse. The oxygen content at any given time may also be read.

All access doors except for escape doors close automatically, so that they do not remain open for longer than necessary. Points at which pure nitrogen can emerge are monitored separately.

The oxygen content rises gradually as a result of the number of airlock movements between the consignment building and the high-bay warehouse, and due to leaks in the building.

As the oxygen content rises, the amount of nitrogen introduced is increased via a valve with a PID control characteristic, and is regulated to produce an oxygen content of about 13.1% by volume.

An alarm is produced if the proportion by volume of oxygen exceeds the limits of 12.9 to 13.4% by volume.

Alarms are signaled to the building control system, which is manned all the time. If the alarms are not acknowledged within 15 minutes, they are passed on via the fire alarm system, as a collective alarm, to the works fire brigade. However, alarms do not in principle lead to switching-off.

All the equipment that forms sparks is switched off only if the oxygen concentration rises further to 13.5% by volume.

All the rack servers, as well as all other motor-driven or engine-driven transport devices and high-speed doors on the airlocks are electrically switched off immediately, with the high-speed doors closing by spring force. The fire protection doors within the airlocks likewise close.

By way of example, two different test sets are used, with gas analyzers based on the paramagnetic alternating, pressure method, manufactured for example by Siemens under the name OXIMAT 61, or technically equivalent equipment, for reasons of redundancy.

The nitrogen is produced by a nitrogen generating system (for example a membrane system), and is transported via an appropriately protected pipeline to the building, or is generated locally. The system supplies the required amount and quality of nitrogen continuously. The delivery process is continuously controlled and monitored via area valves. The monitoring device may be:
flow rate monitoring in the pipeline,
pressure monitoring in the pipeline,
a combination of both.

A constant nitrogen quality is maintained automatically by the control and regulation of the nitrogen generating system. In addition, the data from the system process are sent by remote transmission to the supply organization. This ensures that appropriate servicing personnel are available immediately, when required.

The continuous availability is ensured by a further nitrogen evaporator system, which can be operated without electrical power, as a backup system. The nitrogen is passed into the supply network, with the same quality. The quantities ensure the nitrogens supply (and if required for the rest of the factory as well):
for at least 5 hours quantities for the high-bay warehouse (and possibly for the factory)
after this, quantities to cover the minimum oxygen requirement for the high-bay warehouse.

Delivery is ensured by means of a contractual agreement with the nitrogen supplier. The supply agreement includes the weekend, corresponding to the normal practice for gas suppliers.

In parallel with the remote transmission of the data from the system process to the supply organization, the level of the liquid nitrogen in the backup evaporator system is also indicated in the fire brigade center. Appropriate measures are initiated if the quantity falls below the minimum level.

The entire system is protected against external access by means of a fence, and the liquid gas tank is equipped with driving impact protection.

For permanent functional monitoring of the backup system, the backup system is operated instead of the primary oxygen generating system regularly, at specific times in the year.

The entire system should remain safe all the time.

The following damage situations, for example, are conceivable:

### 1. Electrical Power Failure

The rack servers stop immediately, so that there is no risk of ignition.
The air circulation system stops immediately.
The conveyor belts likewise stop, so that there is no risk of ignition.
The fire protection doors shut automatically, with a time delay.

The system cannot be restarted until the planned operating states have been reached.

### 2. Leaks Caused by Damage to the Building Shell

Alarm via the oxygen measurements.
Electrical power disconnected from all electrical drives if the oxygen concentration is greater than 13.5% by volume.
All procedures for placing goods in store and removing from store are stopped.
The fire protection doors close.

The system cannot be restarted until the planned operating states have been reached. Appropriate repair material is kept available.

### 3. Leaks in the Nitrogen System

Alarm by redundant flow monitoring systems.
The nitrogen supply is switched off via the area valves.
All electrical drives are disconnected, and all fire protection doors are closed.

### 4. Failure of an Air Circulation Fan

Alarm via flow monitoring in the air circulation channel, the air circulation operation is partially maintained via a second fan.

Furthermore, the nitrogen supply is ensured such that there is no immediate danger even in the event of a relatively large hole in the building shell.

Furthermore, in order to avoid an explosive vapor/air mixture, the warehouse air must have solvent removed from it, for example by means of a cleaning system (for example activated charcoal).

The warehouse air is also investigated, for solvents, for example at 24 points in the high-bay warehouse, in the area close to the floor, using equipment whose suitability has been tested. The warehouse area is subdivided into areas each having a side length of, for example, approximately 15*15 m. A pipe perforated on one side is used for induction and is fitted across the diagonal of the respective area. This covers the grid as completely as possible.

By way of example, four measurement points are in this case combined to form an evaluation unit. The evaluation period for each measurement point is about 15 seconds. Concentrations of solvent vapors at any point in the high-bay warehouse can thus be detected immediately by simultaneously checking all six evaluation units.

The evaluation process is carried out using flame ionization detector (FID), which are located in the ex-free area.

Further measurements are carried out:
in the collection channel on the induction side of the air circulation system, using measurement heads functioning on the heart of reaction principle,
in the respective switchgear cubicles on the rack servers, with the signals being transmitted by data radio.

In the case of values
>1% LEL (Lower Explosive Limit of the vapor/solvent mixture), a message is sent to the building control system.
>7% LEL, all the rack servers move to the transfer position and are switched off. All other engine-powered or motor-powered equipment, such as transport devices and high-speed doors for the airlocks, switch off. The fire protection doors within the airlocks close.
>10% LEL, all rack servers brake to a stop immediately, and are switched off.

The ventilation system continues to operate.

The solvent-loaded air in the room can be passed into free space at a safe point, or can be cleaned, via a flow element of the circulating air in an already laid channel. At the same time, a flow component of fresh nitrogen may be added, if appropriate.

Further preferred embodiments, details and advantages can be found in the dependent claims and in the following description.

The warehouse comprises the automatic high-bay warehouse according to the invention as well as a consignment zone and loading zone and a recreation and office area arranged in a subarea of the consignment and loading zone. Permanent workstations are set up in the two last-mentioned subareas, where the atmospheric conditions are normal, that is to say approximately 21% by volume of oxygen. The warehouse is provided for approximately 30500 pallet locations, in which a total of 12600 tonnes of goods that are essentially ready for dispatch can be stored. The stored goods are subdivided essentially into 3100 tonnes of VbF substances in hazard classes A I, A II and B, as well as approximately 6400 tonnes of other combustible liquids, which are not subject to the area controlled by the VbF owing to the viscosity clause or because the critical flashpoint of 21° C. for liquids which can be mixed with water or 55° C. for liquids which cannot be mixed with water (AIII or unclassified in accordance with the VbF) is exceeded. Furthermore, the total amounts stored in the warehouse include approximately 2000 tonnes of powder paint, for example on a polyester basis. The high-bay warehouse itself extends over a length of approximately 119 m and a width of approximately 45 m, thus covering a base approximately 5355 m². The unobstructed height of the high-bay warehouse is approximately 30 m. The consignment zone, physically separated from the loading station for fork-lift trucks and the machine store, extends in an equivalent manner in an L-shaped arrangement with its main section over an area of 162×33 m, and with an adjacent extension of 58×25 m, thus covering an area of approximately 6796 m².

An engineering area is located in the basement under the consignment and loading zone on an area of approximately 800 m², and accommodates installations for the building connection (gas, water, electricity) and the special technical facilities for the sprinkler system and the nitrogen generation for the permanent oxygen-reduction system for the high-bay warehouse. This area has its own independent access, direct from the exterior. The loading bay is located on the east side of the consignment and loading zone. The nitrogen can also be supplied externally, via protected pipelines.

The fire protection will be described first of all in the following text.

The load-bearing components of the high-bay warehouse can be provided using an unprotected steel structure overall, since no fire can occur as a result of the oxygen reduction. In this case, the rack system is designed to be self-supporting and self-stiffening (silo structure) using a type of steel structure. The outside walls and roof fittings are in this case attached to the rack system. The high-bay warehouse system has a catchment trough at a level of about 1.30 m. The media-resistant seal is in this case composed of an HDPE plastic sealing web. This is followed, up to the level of the consignment zone, by a steel sandwich wall structure and, in the upper area, horizontally arranged industrial glazing. The load-bearing components of the two-floor area of the consignment zone, together with the office and recreation area located there, are designed using a type of reinforced concrete structure that complies with fire resistance class F90 in accordance with DIN 4102. The roof over the office and recreation area is in the form of a reinforced concrete sheet without any openings and which is at least fire-resistant. The single-floor area of the consignment and loading zone is provided with reinforced concrete supports and with steel ties resting on them, as a roof support. The roof structure uses trapezoidal steel plate elements, noncombustible heat insulation on top, and a sheet seal. The design is based on consistent use of noncombustible building materials.

The high-bay warehouse and the logistics building are effectively separated from one another, for fire protection purposes, by constructing a fire wall in the sense of the Building Regulations for North-Rhine Westphalia and DIN 4102 and are accordingly certified as being respectively separate fire sections. However, the high-bay warehouse itself is constructed without fire sections.

This fire wall is in this case passed over the roof of the consignment and loading zone up to 5 m, and is continued horizontally 7 m above the inner corners. The wall of the west side of the consignment zone is furthermore continued to a distance of 30 m from the inner corners between the two building bodies, in compliance with fire resistance class F 90-A, by means of a permanent supporting system for the areas formed by the reinforced concrete supports. The roof cover for the logistics building, adjacent to the high-bay warehouse installation with an area of 18 m, is designed to be fire-resistant (fire resistance class F 90-A). In addition to the requirements in the high-bay warehouse directive, the roof area is thus produced in accordance with fire resistance class F 90-A such that it is closed to a considerably greater depth in front of the projecting east high-bay warehouse wall and over the entire length of the fire wall and its extension, as described above, thus effectively preventing fire from propagating to the high-bay warehouse that is to be protected.

This not only makes it possible to dissipate smoke and heat and for the fire brigade to work in the event of a fire in the consignment zone, but also reduces the load on the physical structure by the extraction of heat if the fire does propagate.

The roof area, which is closed to a depth of 18 m, also means that, in the event of a serious fire int he consignment zone, the high-bay warehouse is thermally loaded only to a limited extent due to the distance from the flame front that is to be expected in the event of failure of the roof surface, which is not fire-resistant.

Furthermore, the outer walls of the high-bay warehouse adjacent to the consignment zone—in the area above the fire wall and—in the area up to a distance of 30 m away from the inner corner with the consignment zone, are designed to be noncombustible in the event of a serious fire in the consignment zone.

A facing shell composed of concrete elements is used, in order to provide the eastern end wall with a certain amount of resistance to containers crashing into it or other fragments in the event of containers bursting.

The thermal radiation produced in the event of a serious fire in the consignment zone is dissipated by spraying water over the entire covering surfaces of the described outer wall areas. This spraying system is actuated automatically with the initiation of the sprinkler system in the consignment zone, and is thus highly reliable in terms of spurious initiation. A manual initiation point can be provided.

The warehouse, which is based on a silo structure supported by racks, is operated unmanned by means of 11 rack servers. While the consignment and loading zone is intended to be protected by means of a conventional sprinkler system with film-forming foam agents added as an extinguishing system, protection in the form of permanent oxygen reduction, for fire avoidance, is provided for the intended warehouse heights and stored goods for the high-bay warehouse.

The warehouse is entered through numerous doors or gates in the surrounding walls. In addition to the doors that are required in order to provide rescue routes, access doors, which are provided for enquiries and for extinguishing action, are provided in the extensions of the fire wall in the western outer wall of the consignment zone. The office and recreation area is accessed via an externally located stairwell, which complies with the building regulations, and a further staircase which is required as a second rescue route, for access on foot. The entire building is free-standing, can be driven all the way round by fire brigade vehicles and is surrounded by a safety zone, in which there are no other buildings.

The high-bay warehouse is used for storing manufactured goods. The total quantity of goods in store is intended to be 12600 tonnes of manufactured goods, of which a maximum of 3100 tonnes are VbF products and a maximum of 6400 tonnes are other combustible liquids, with the powder paints on a polyester basis which are to be stored in the high-bay warehouse being combustible substances which can form explosive mixtures, due their capability to flow freely as a fine distribution in air (see above).

As stated above, the maximum warehouse height is in this case about 30 m (top edge of the stored goods). The high-bay warehouse is operated completely automatically, which in turn means that it is entered only for maintenance purposes and repair purposes. However, access to the high-bay warehouse must be ensured at all times.

Products are placed in store, are removed from store and are consigned via the consignment and loading zone at the front. The goods are supplied from the works via a door on the south side of the consignment and loading zone. The products in this case pass via a functional area with sorting and consignment facilities and via the associated airlocks into the high-bay warehouse, and are in this way removed from store, consigned, packed, loaded into goods vehicle, or passed on for dispatch by rail.

The method of operation of the fire prevention system by oxygen reduction will be described in the following text. The combustion system comprises necessary preconditions of varying types. These are firstly the material conditions for fuel and oxygen. If these are present in a suitable quantity ratio as required for combustion, the combustion reaction can occur due to further energetic preconditions including ignition energy and the minimum combustion temperature. In this case it is important to know that fuel and oxygen can react only when they are present in a stoichiometrically suitable quantity ratio. A fire can be extinguished by disturbing this quantity ratio or else the energetic preconditions. Thus, for example, the use of water in the combustion zone for extinguishing either extracts energy, or thinning of the oxygen in the air changes the quantity ratio such that it is no longer possible for a fire to continue to burn. Gases such as carbon dioxide (CO₂), nitrogen or gas mixtures (Inergen=nitrogen/argon) are used in extinguishing systems for the last-mentioned case.

In the case of oxygen reduction, the reduced oxygen content directly impedes the start or progress of the combustion reaction, so that a state is permanently produced which corresponds tot he state of an area after initiation of an extinguishing system. According to prEN ISO 14520-1 (fire extinguishing systems with gaseous extinguishing agents), the concentration of the fire extinguishing agent which is effective for extinguishing must not only be reached but must also be contained for a sufficiently long period in order to make it possible to effectively extinguish a fire. This requirement applies to all fire classes, since a permanent ignition source, such as an arc or a deep-seated fire can lead to the initial event resuming once the extinguishing agent has been consumed. For this reason, the abovementioned relevant standard specifies a maintenance period, during which the concentration of the extinguishing agent must be maintained. The maintenance period must be at least 10 minutes and, at the end of the maintenance period, the extinguishing agent concentration must still correspond at least to the effective extinguishing concentration. The concentration of the extinguishing agent may thus fall from the nominal concentration to the extinguishing concentration during the maintenance period of at least 10 minutes. A further advantage of an oxygen-reduced area is that the maintenance time which needs to be provided for the configuration of a gas extinguishing system for the extinguishing gas concentration to be maintained is particularly long for a building that has been made inert, owing to the special sealing of the building shell.

Nitrogen has already been used for a long time in the chemical industry for inertization of fire-risk and explosion-risk processes. This is done, for example, in the inertization of tanks and pipelines, silos or fires in mines. The oxygen concentration in a storage area can thus be reduced to such an extent that a fire can no longer start.

The result of this consideration is also that there is no need for any further conventional fire protection measures such as fire identification, fire fighting or bounding of the effects of a fire. There is thus no need in oxygen-reduced areas for—fire resistance of the supporting structure—fire alarm systems—sprinkler systems or other extinguishing systems—smoke or heat extraction systems. However, such additional measures may, of course, by provided for safety reasons.

This procedure is based on the start of a fire which must first of all reach a specific accepted extent in order to allow further fire protection measures, which are then active, such as a fire alarm and extinguishing measures, to come into action. On the other hand, the oxygen reduction has the critical advantage that it prevents a fire itself from starting, thus also avoiding the failure probabilities of conventional fire protection systems.

As a fire prevention technique, oxygen reduction has the major advantage over conventional protection methods that a fire, which must initially be identified by other techniques in order then to fight it, cannot start in the areas protected in this way. The advantages of oxygen reduction over other fire protection systems can be described in detail, as follows.

Since sprinkler systems cannot entirely prevent fire, it is therefore necessary to expect that a fire will occur with consequential smoke damage, as well as the use of the extinguishing agent resulting in water damage even to objects in the facility and stored goods which are not effected by the fire itself. Sprinkler systems may fail when the rate at which the fire propagates is greater than that expected and, in consequence, the effective area as described in the design rules for the sprinkler system is exceeded. This is a particular concern in the case of high-bay warehouses, for protection of warehouses containing combustible liquids. The sprinkler statistics from the companies insuring against damage additionally indicate the following failure sources: faults in the water supply, faults in the alarm valve station, sabotage, system not ready to operate, incorrect design, failure of physical separation.

Fire alarm systems are suitable devices for identifying that a fire has started and for warning persons present, if appropriate to try to extinguish the fire themselves, and to call the fire brigade. The fire cannot be approached by the fire brigade, and then fought, until this has been done.

Extinguishing systems using gaseous extinguishing agents, such as carbon dioxide or nitrogen, require a space with defined sealing owing to the requirement for extinguishing gas, that needs to be defined for the particular configuration. Openings which are introduced subsequently into the surrounding walls of the area to be protected and which were not included when planning the extinguishing system restrict the reliability of the extinguishing system by allowing the extinguishing agent to flow away in an unacceptable manner, and by allowing oxygen in the air to enter too quickly. Furthermore, it is necessary to remember the fact that many extinguishing gases act by displacement of oxygen, and/or in the case of carbon dioxide are even toxic. For this reason, initial warning times are required before the extinguishing process, which delays the actual extinguishing process and thus initially allows the fire damage to become greater. Extinguishing gas which passes through openings which have not been approved into adjacent areas can seriously endanger persons there.

In contrast to the characteristics of other extinguishing gases described above, nitrogen is not toxic and is thus environmentally friendly. Since fires cannot start in an oxygen-reduced protection area, no fire products are produced, such as carbon monoxide, carbon dioxide or other environmental toxins. There is likewise no need for material for throwing onto a fire or for means for restraining the extinguishing agent. In comparison to sprinkler systems, the oxygen reduction can be chosen very largely independently of design parameters which are highly differentiated for sprinkler systems.

With regard to the long-term reliability of the protection effect, it can be stated that the oxygen reduction system continuously monitors the residual oxygen content in the area to be protected, and thus ensures the effectiveness of the area protection at all times. A further major advantage of the use of oxygen reduction for protection of a high-bay warehouse that may be mentioned is that, even if the nitrogen production fails, the hermetic sealing of the building continues to ensure fire protection for a very long time while, in contrast, damage situations are repeatedly reported in buildings with conventional extinguishing systems, in which the extinguishing systems were not ready to operate owing to maintenance work or major control errors.

The following measures are taken in order to provide the greatest possible safety against the starting of a fire and the creation of an explosive atmosphere in the high-bay warehouse.

The stored goods, which are delivered on pallets, are subjected to contours monitoring in order in this way to identify discrepancies from the nominal parameters and, possibly, packages that have been tilted. This prevents packages from running into one another, crashing and in consequence causing leakages. Furthermore, a measurement is carried out of organic solvent vapors released from the packaging, and for smoke identification. In order to improve the reliability, this identification is carried out within a detection tunnel. Stored goods are not released for storage in the high-bay warehouse until they have been tested in this way satisfactorily.

Furthermore, the warehouse is equipped with a conventional fire alarm system. Smoke is used as the characteristic variable for fire alarms in the area of the consignment zone, of the offices and of a number of other rooms that require particular protection. In the area of the high-bay warehouse, the use of fire alarm technology is restricted to those areas in which detection is worthwhile. These are the switchgear assemblies and the switching devices carried on the rack servers. There is no need to equip the high-bay warehouse with any further fire alarm devices, since the start of a fire which can initiate a conventional smoke alarm in accordance with EN 54-7 is not feasible in the high-bay warehouse, in which the oxygen is permanently reduced.

The initiation threshold for an alarm such as this occurs at an extinction level (reduction in the air transparency of 5-6% m. This threshold is defined as a trade-off between experience with disturbance variables (swirling dusts etc.), on the one hand and the necessary tripping reliability on the other hand.

A smoldering fire in damaged cable systems and glowing heat sources in the surrounding packaging of stored goods that originate despite the complex monitoring measures are regarded as events which can release the fire aerosols in the high-bay warehouse.

Heating of electrical drives can reliability prevented since their temperatures are monitored from the viewpoint of explosion protection, so that surface temperatures of more than 160° C. cannot occur.

The residual oxygen content of about 13% by volume also means that pyrolysis processes which are initiated by introduction of external energy (electrical installation) cannot propagate, so that it cannot be expected that smoke will be developed from them in a concentration such that a fire alarm system could be initiated.

It can thus be stated that the pyrolysis processes mentioned cannot propagate in a manner threatening danger in the oxygen-reduced atmosphere, and, for this reason, there is no need to install fire alarm technology.

The possibility of a damage event propagating as a result of a short circuit with the subsequent continuing introduction of energy into the cable material in the electrical installation should, however, be considered separately here. It is known that PVC cable insulation on horizontally routed cable harnesses is self-extinguishing after a massive supporting fire in a normal atmosphere and a fire can no longer propagate. However, vertical cable harnesses tend to allow fire to propagate in a normal atmosphere owing to the fire that is produced by the cables themselves under the cable installations. In order to reliably prevent the propagation of such a charring fire along harnesses of vertical cable installations in the high-bay warehouse, these supply cable harnesses are additionally provided with a barrier layer forming means for oxygen reduction. This forms a foam when heated and thus prevents oxygen from heating the cable which has been heated, for example, by a short circuit, so that the damage event cannot propagate.

Further feasible disturbances which release heat are the short-circuiting of an electric motor in a rack server or a brake running hot. These disturbances are identified by monitoring the nominal states of the temperature and power consumption of the respective devices, and by switching them off if there is any discrepancy from this nominal state. This monitoring is intended to ensure the maximum possible availability of the high-bay warehouse from the operator's point of view. However, any failure of the described components has no effects on the protection aims, which are satisfied by the oxygen reduction in the high-bay warehouse and by the fire prevention achieved in this way.

In addition to indication of the opening state of the fire protection closures, which are provided with fixing systems, temperature monitoring is provided in the area of the airlocks for the high-bay warehouse, in order to provide the fire brigade with the capability to intervene when a reference temperature is exceeded.

In accordance with paragraph 3.6 of VDI 3564—August 2002 issue—high-bay warehouses must have smoke and heat extraction systems which must be planned such that they are distributed uniformly in the roof area. The smoke and heat extraction system equipment must in this case have a test certificate (ZPZ) in accordance with DIN 18 232 Part 3. These requirements in this case take account of the presence of an automatic extinguishing system based on a sprinkler system, which must suppress the production of the smoke gas in the event of a fire.

Since the installation of a permanent oxygen-reduction system in the high-bay warehouse according to the invention means that it no longer possible for combustible substances to ignite within the high-bay warehouse, the start of a fire there, with corresponding smoke production, can be precluded. It should also be remembered that smoke extraction (thermally or mechanically) acts counter to the fire prevention system by extracting the oxygen-reduced atmosphere in the high-bay warehouse. No major measures are therefore provided for removing smoke from the high-bay warehouse.

Measures to restrain extinguishing water are not required in the case of the oxygen-reduced high-bay warehouse since the use of oxygen reduction as a measure for fire prevention makes it possible to preclude the start of a fire, and there is therefore no need to use extinguishing agents or automatic extinguishing by means of water, either. The physical configuration of the high-bay warehouse plinth equally means that there is a 1.30 m high trough with a volume of about 6900 m³, in which product and if necessary extinguishing water can be restrained. Reliable acquisition and dissipation of extinguishing water which is used for cooling the high-bay warehouse system in the event of a fire in the consignment and loading zone is provided deliberately to a retention basin over a 2 m wide area, which surrounds the high-bay warehouse and is sealed by HDPE sealing webs.

A risk assessment for the high-bay warehouse based on VDI 3564 “Recommendations for fire protection in high-bay warehouse systems” leads to a maximum permissible fire section size of 6000 m², although there are likewise no requirements here for the fire resistance of the load-bearing components. This maximum permissible fire section size is greater than that in this specific situation, with the high-bay warehouse having an actual size of about 5355 m².

One fundamental precondition in this case is the oxygen reduction, which is still to be described in the following text, as a primary measure, based on risks, with regard to the automatic extinguishing system based on a sprinkler system as required in accordance with VDI 3564.

When determining the maximum permissible size of the fire fighting sections, it is assumed that the high-bay warehouse is effectively separated, for fire protection purposes, from the consignment and loading zone in front of it by the construction of fire walls in the sense of the State Building Regulations and DIN 4102. The high-bay warehouse may itself, however, be constructed without fire sections, as a result of the use of oxygen reduction.

The fire walls are in this case not continuous at the point immediately under the roof of the high-bay warehouse. They are accordingly continued at least up to a point under the roof of the consignment and loading zone and, furthermore, the roof surfaces which are adjacent to the vertical outside walls of the high-bay warehouse are designed without openings to a depth of at least 7 m in accordance with VDI 3564, and are designed to fire resistance class F 90 in accordance with DIN 4102 (see above).

As a result of the special risk analysis of the present warehouse, the fire wall is continued to a point 5 m above the roof of the consignment zone, and the adjacent roof area is continued at a depth of 18 m as far as the roof support there, in accordance with fire resistance class F 90-A. The supporting components, that is to say the load-bearing components, of this roof area reinforcement are in this case likewise fire-resistant, with this being achieved by means of the reinforced concrete type of structure for this area. Heat insulation is provided for all roof surfaces using noncombustible building materials.

Furthermore, the fire walls are continued around the corners in the region of reentry corners in accordance with the requirements of VDI 3564, in such a way as to provide a horizontal fire flash over separation—measured across the respective inner corner—of at least 7 m, and 5 m in the region of the separation between the office zone and the consignment zone.

The western outer wall of the consignment zone is produced as an extension to the continuation of the fire walls around the corners for a further 23 m using sand-lime brick masonry in accordance with fire resistance class F 90-A. Further doors in this wall, which are expedient for fire fighting this area, are in the form of T30 doors.

Any openings required in the fire walls are tightly sealed by means of a fire protection closures, which are licensed by the building authorities, to fire resistance class T90 in accordance with DIN 4102.

In the course of conveyor systems, fire protection closures are used in conveyor systems that are based on rails. If fire protection closures are kept open during use, then fixing apparatuses which are licensed by the building authorities and which automatically seal the closures when smoke is developed are used exclusively for this purpose. It is compulsory for closures that are based on rails to be equipped in this way. Fire protection closures which are provided with fixing systems are closed outside working hours. In order to ensure this, the doors are appropriately marked and, furthermore, the opening state of the doors is indicated at the works fire brigade control station.

In order to avoid ignition hazards, electrical equipment which is used in the warehouse complies with the normally applicable VDE rules for this purpose.

To the extent that openings in walls and ceilings are provided with the necessary fire resistance duration (see above), then these are closed within the object to be assessed, at least in the following fire resistance classes:

| Bulk component | Closure |
|---|---|
| Fire wall | R or S 90 |
| F 90 separating wall | R or S 90 |
| Ceiling | R or S 90 |

Furnace systems within the site are arranged exclusively in the area of the upper floor of the logistics building. The heating and furnace systems are produced in accordance with the furnace regulations of the German Land of North-Rhine Westphalia. Surrounding walls for these engineering areas are designed to fire resistance class F 90, and with self-closing fire protection closures T30.

Double floors with a size of more than 20 cm are provided underneath the consignment zone and in the server area (office area) in the region of the low-voltage and medium-voltage switchgear rooms. This area is provided with automatic smoke alarms.

The entire warehouse is equipped with a lightning protection system in accordance with the recognized rules of technology. This lightning protection system is designed in accordance with the Allgemeine Bedingungen des Blitzableiterbaues e.V. [General Conditions for Lighting Construction], in conjunction with DIN VDE 0185.

The high-bay warehouse (with at least 0.4-times air circulation) and the consignment and loading zone (at least twice, of which 0.4-times fresh-air and 1.6 air circulation) are provided with space ventilation systems and air circulation systems.

With regard to the high-bay warehouse, there is a discrepancy here from the VbF regulations, which demand a 0.4-times fresh-air change per hour. The required air changing rate is, however, compensated for by protected leakage monitoring by the solvent detectors. The circulation of the high-bay warehouse air that is carried out in the present case produces the same effect with respect to absorption of the vapors which may be released. Hazardous enrichment of the warehouse air with organic solvent vapors is monitored by means of suitable approved equipment.

No smoke extraction measures are required for the high-bay warehouse, since effective measures are taken to prevent the start of fire—and hence smoke production—by the installation of permanent oxygen reduction. It should also be remembered that smoke extraction (thermally or mechanically) runs counter to the fire prevention technique by extracting the oxygen-reduced atmosphere from the high-bay warehouse.

The warehouse is equipped with an alarm device as an internal alarm in order to ensure the escape route lengths, as described above, in accordance with the Industrial Building Directive. This alarm also signals any excessively low oxygen content which may occur in the consignment zone area due to nitrogen emerging from the high-bay warehouse.

Internal signal transmitters (sirens, horns, etc.) are actuated as alarm devices by monitored transmission paths from the fire alarm system (in accordance with VDE 0833 Part 2) in order to provide early warning for the personnel throughout the entire site. The alarm device signals differ from signals used during operations and, in the case of acoustic alarms, from the general noise level (interference sound level), and exceed this level by 10 dB (A) at all times. Visual internal signal transmitters are additionally used where the noise levels are above 110 dB (A) (in accordance with VDE 0833, DIN 33 404-3).

The warehouse is equipped with emergency lighting in accordance with the applicable rules of technology for this purpose. The emergency lighting has a standby power source which is independent of the mains supply and which switches itself on automatically within one second in the event of a mains power failure. The lighting intensity of the emergency lighting is at least 1 lux.

The rescue route indications are in this case likewise connected to a power supply system for the emergency lighting.

An emergency power supply is provided for the warehouse and, in the event of failure of the general power supply, takes over the operation of the safety systems and facilities, in particular the emergency lighting, lighting of the notices for exits, the fire alarm system, smoke and heat extraction systems, where these are electrically powered, the monitoring system for oxygen reduction in the high-bay warehouse, explosion limit instruments and minimum oxygen concentration measurement in the consignment zone.

The emergency power supply system complies with VDE 0108. The nitrogen generation for the permanent oxygen reduction system is carried out by the membrane system, by means of the cold evaporator for liquid nitrogen, in the event of a power failure. In the event of a power failure, the sprinkler system is operated by means of a diesel pump. The accommodation areas for the standby power supply systems (batteries, power generating sets etc.) are separated from the surrounding rooms in compliance with the fire resistance class F 90. Any ventilation systems required for these areas are passed through external areas or directly to free space by channels that comply with fire resistance class L 90.

The thermal energy which acts on the high-bay warehouse in the event of a serious fire in the consignment zone is dissipated by spraying water over the area of the eastern end wall and the adjacent 30 m long outer wall areas. The spraying device may be designed, for example, in accordance with the rules for designing water spray extinguishing systems in DIN 14 494 of VdS 2109. This spraying system is activated automatically with the initiation of the sprinkler system in the consignment zone, and is thus highly reliable against spurious initiation. An additional manual initiation point is likewise provided. The automatic spraying system can be switched off separately, for test purposes.

The following measures are provided in order to ensure the reliability of the protection systems: the areas in which they are accommodated are separated from other building parts in accordance with fire resistance class F 120; angled surfaces to the light well ensure that the areas cannot be submerged by extinguishing water; the power supplies to the air decomposition system and the sprinkler control center are laid underground, and are provided with a standby power supply from a diesel set.

Wall hydrants are additionally provided adjacent to the access doors in the consignment and loading zone.

With the exception of the high-bay warehouse itself, portable fire extinguishers are installed, such that they are available for use at all times, at easily accessible points in the warehouse. The equipment comprises portable fire extinguishers in accordance with DIN EN 3. The fire extinguishers are preferably arranged in the vicinity of the emergency exits or wall hydrants. The dimensions correspond to the requirements of the Workshop Law. The number and nature of the extinguishers required comply with BGR 133 “Rules for the equipment of workshops with fire extinguishers”.

In order to assist any extinguishing action which may be necessary for the high-bay warehouse, dry vertical pipelines can be routed up to the roof of the high-bay warehouse in accordance with paragraph 4.5 of VDI Directive 3564, August 2002 issue, on a side which is accessible for the fire brigade. It is sensible to provide these at the point at which a staircase leading to the roof of the high-bay warehouse is provided.

Furthermore, pipe busing matching the diameter of a B pipe are provided alongside the access doors into the high-bay warehouse in order to assist any internal action required by the fire brigade, if necessary, for cooling the doors in the fire wall. In the normal state, these are provided internally and externally with blank couplings in order tin this way to prevent oxygen from entering the high-bay warehouse in an impermissible manner.

There is no immediate hazard which needs to lead to intervention by the emergency services even if combustible liquids are released from relatively large containers in the high-bay warehouse, since the explosion protection measures make the risk of ignition and explosion sufficiently improbable, and no fire can develop owing to the reduction in oxygen. There is therefore no need to call fire brigade personnel to provide a defense against hazards in the event of products escaping into the warehouse, and it is possible to wait until the atmosphere in the area has absorbed the combustible vapors and, if appropriate, these have been extracted via the cleaning system tot he atmosphere. To this extent, this results in a considerable reduction in the hazard potential to be copied with by a works fire brigade.

Nonetheless, intervention by the fire brigade when personnel are available is still possible since the structure that is provided also allows propel to enter using the control server vehicles, and to carry out work from them. An emergency exit for a general power failure is likewise provided.

Furthermore, a fire brigade plan in accordance with DIN 14 095 has been worked out for the warehouse, in close collaboration with the works fire brigade, the responsible fire protection department and the city fire brigade.

This fire brigade plan includes at least the following details: 1. Extinguishing water extraction options in the area around the site to be assessed. 2. Location and movement options for the brigade, including access options to the site. 3. Central starting points for taw works fire brigade (fire alarm control center) including the initiating devices for fire protection systems (smoke and heat extraction systems etc.). 4. Subdivisions and partitioning to provide fire protection. 5. Description of the escape routes and rescue routes, exits, emergency exits, stairwells and escape routes which can always be used safely and in a protected manner. 6. Details relating to particular major hazard locations and preconditions which should be assessed as being particularly critical in terms of emergency service tactics. 7. Information about areas which are relevant for emergency service tactics (engineering control centers, ventilation control centers, building connection rooms, etc.).

Technical systems and facilities are accepted and monitored in accordance with § 54 of the Building Regulations for North-Rhine Westphalia, on the basis of the Order for Testing Technical Systems and Facilities of special installations by state-recognized experts and by specialists—Technical Test Order (TPrüfVO).

Liquids and solids in the form of dust are stored in the high-bay warehouse (see above).

A major proportion of these liquids are able to form an explosive atmosphere at room temperature. Some of these combustible liquids are combustible liquids in the sense of the “Order on combustible liquids (VbF)” (see above). The solids in the form of powder include, in particular, powder paints based on polyester. They should be regarded as being combustible and have the capability to form an explosive atmosphere after being lifted into the air by vortices.

For fire protection reason, the high-bay warehouse is operated in an atmosphere with a reduced oxygen content (see above). The following explosion protection measures must not contradict this fire protection concept.

No explosion hazards can occur during normal operation of the warehouse, since the combustible substances re stored in containers which are approved in accordance wit the hazardous gods laws. The containers in practice form a seal for the substance in them.

However, despite automated operation, it is statistically possible, owing to the size of the warehouse for, example, a container on the storage rack location to be damaged or to fall down and become damaged. This is admittedly improbable owing to the goods-inwards inspection (see above), but it is possible. For safety reasons, it is therefore necessary to consider the emergence of combustible substances and the formation of dangerous explosive mixtures.

All engineering devices and equipment up to a height of 0.8 m above the floor must comply with the requirements of ex zone 2. These requirements apply in the logistics systems but not to components of the conveyor system, since these are all located more than 0.8 m above the floor.

The reduced oxygen content in the warehouse atmosphere results in the safety characteristic variables being shifted “in the safe direction”, although the portion of inert gas is not yet sufficient to completely prevent explosions. However, the probability of an explosion occurring at all is reduced and, if such an explosion nevertheless occurs, its effects are reduced.

Vapors from non hazardous minor leakages are picked up, diluted and transported away by the circulation of the warehouse atmosphere. Only a small proportion of the atmosphere is ejected into the environment (possibly via suitable filters), and the majority is fed back in the circuit of the air circulation system.

Any emergence of combustible vapors or liquids is identified by means of the solvent detectors (gas warning devices). Measurement points are arranged distributed in the extraction line and in the warehouse area.

In a multistage concept, measures are taken manually and autonomously, that is to say automatically, in order to ensure that the concentrations of organic vapors in the atmosphere do not rise above a value which is equal to the value of 50% of the LEL in air, in particular 20% and preferably 10%, and in a very particularly preferred manner 1% of the LEL in air.

However, since any combustible substances which emerge are diluted to a major extent by the circulation of the warehouse atmosphere, and even minor leakages which are well below the explosion hazard levels should be identified at an early stage for safety, the actual warning and alarm thresholds should be set considerably lower, in particular to <20% and preferably to <10%, and very particularly preferably to about 1% of the LEL in air.

If a rise in the concentration of combustible substances in the atmosphere cannot be prevented despite the measures that have been taken, then operation of all equipment is stopped, except for those items which comply at least with Category 3G, and which should also still be operated during rectification work. This relates in particular to the ventilation system, to those parts of the gas warning system which are located in the warehouse and, possibly, to parts of the lighting system.

Relatively large volumes of combustible liquids are absorbed by adsorption means, and the area in question is cleaned. If relatively large pools cause problems, then it is also alternatively possible for the pool to be covered with foam by the fire brigade on an individual basis, since the high-bay warehouse can still be entered, because the proportion by volume of oxygen is about 13% by volume.

Any combustible dusts that emerge cannot be identified by the gas warning device. The danger that they present is that, once they have been deposited, they can be lifted up into the air again by a vortex at some later time, in which case they can then once again from explosive mixtures.

The majority of the dusts that occur are removed continuously from the warehouse atmosphere during operation by means of filters that are installed in the air circulation system. The filters can be accessed via suitable gangways for maintenance of the air circulation system, and are regularly replaced or cleaned.

Inspection procedures are carried out regularly in the high-bay warehouse area in order to identify (relatively large amounts of) combustible dusts that have emerged. Dusts are removed manually in the correct manner, for example using a suitable vacuum cleaner that has no ignition sources for sucking up combustible dusts. If an explosive mixture caused by combustible vapors is present at the same time, then the vacuum cleaner must also be free of any ignition sources with respect to combustible gases or vapors.

The combustible gases and vapors which remain in the atmosphere are removed from the circulating gas by means of an activated charcoal filter. If necessary, a separate fan and/or a mobile activated charcoal filter can be used for this purpose.

In the other areas, explosion hazards may occur only in the event of serious malfunctions. Measures are required on an individual basis here.

The atmosphere in the consignment zone area is monitored by means of gas warning devices, and if combustible vapors are identified in the air, the air replacement rate is increased and only environmental air is supplied.

As a protective measure against spreading from a container which is nevertheless leaking, the warehouse floor is in the form of a catchment trough for the high-bay warehouse. In order to prevent combustible vapors or explosive mixtures from being dragged into neighboring areas, airlocks are provided between the high-bay warehouse and the consignment zone area, thus preventing explosive mixtures from being passed over in this area, so that it is impossible for explosive mixtures to occur. In order to ensure that no leaking containers are moved from the consignment zone area into the high-bay warehouse, they are checked in the consignment zone area before being placed in store. A gas trough system (for organic solvents) is for this purpose installed in the area of the contour test carried out on the pallets before they are placed in store (see above).

Within the multistage concept described above, a warning is passed to a continuously manned control center if a warning limit of 10% of the LEL is exceeded. A visual inspection is then carried out of the warehouse interior, if appropriate with the source for the organic components in the warehouse atmosphere being identified. If an alarm threshold of 20% of the LEL is exceeded, all equipment which does not satisfy the requirements of Category 3G is switched off.

For the sake of safety, these respective thresholds may be reduced, for example, to about 1% and to about 10%.

If the maximum value is nevertheless unexpectedly exceeded, then the air circulation system is speeded up to double the rate at which the air in the warehouse atmosphere is changed per hour, until the levels once again fall below the LEL alarm thresholds. If necessary, further nitrogen is additionally blown in, and the warehouse atmosphere is cleaned of solvent vapors by means of activated charcoal filters, and/or if necessary with a flow element being dissipated into the environment.

In addition to automatic initiation via the appropriate gas warning devices, manually operated switches are provided for manual initiation of the switching-off of all equipment. Once an appropriate warning or alarm threshold is reached, the emerging combustible substances are, of course, removed in the officially approved manner without delay, in addition to doubling the air replacement rate, if necessary by manual absorption by means of adsorption means.

The rest of the explosion protection measures in the warehouse are based on the solution proposals in TRbF 20 (Technical directives for combustible liquids).

A preferred arrangement of the monitoring device for monitoring the proportion by volume of oxygen in the atmosphere of the high-bay warehouse, and a preferred embodiment of the monitoring method are described with the attached drawing.

The high-bay warehouse 100 includes a space 1, which has two material airlocks 2 and a personnel airlock 3. Transport of material and passage of personnel between the high-bay warehouse and a space 4 arranged in front of it for consignment, can occur though these airlocks.

In the high-bay warehouse 1 a circulation device is provided for the circulation of the atmosphere located in the high-bay warehouse. It includes a plurality of induction openings 5, which are located in the lower region of the high-bay warehouse and represented only schematically in the drawing, where the atmosphere is inducted through said openings, as symbolized by the downward directed arrows.

The creation of the induction capacity serves two blowers 8, 9 active in the lines 6, 7, the inducted atmosphere is fed via the blowers to the emission openings 10, which are located in the upper region of the high-bay warehouse. The flow of the exiting atmosphere is again symbolized by the downward directed arrows.

A plurality of O₂ measurement points O are provided in the space 4 for the consignment, as in the region of the airlocks 2, 3, and also in the high-bay warehouse, where these measurement points are connected with three analysis devices, which are not represented in the drawing.

The measured values of O₂ determined by the analysis devices are used if necessary, i.e. if the oxygen concentration exceeds a predetermine value, to supply nitrogen via the line 11 into the lines 6, 7.

The control of the nitrogen supply occurs using a control valve 12 active in the line 11. For an increase in safety, a check value 13 is downstream from the control valve 12, where using the check value in the case of a malfunction of the control valve, the supply of the nitrogen can be discontinued.

In addition, a filter device 14 is provided outside of the high-bay warehouse, where the filter device includes the individual filters F3 and F6. These can be switched into the circulation loop over the lines 14, 15, and 16 such that during the circulation the atmosphere flows successively through the individual filters supported by the additional blowers 17, 18.

In normal operation the filter devices are not located in the operation. They are only activated in the case of damage, for example, if the atmosphere is contaminated by leaking solvent.

What is claimed is:

1. A method for fire and explosion protection in a high-bay warehouse for hazardous chemical substances and, in particular, for Class AI and B VbF [order on combustible liquids] substances, by
reducing the proportion by volume of oxygen in the atmosphere within the warehouse by permanent inertization by means of a barrier gas, in particular nitrogen, preferably to a value of between 12.9 and 13.4% by volume,
monitoring of the proportion by volume of oxygen in the atmosphere,
ensuring an at least virtually homogeneous distribution for the oxygen-reduced atmosphere in the warehouse,
monitoring of the proportion by volume of solvent in the atmosphere,
circulation of the atmosphere in the warehouse,
as great as possible an avoidance of the use of ignition sources,
removal of gaseous substances from the atmosphere in the warehouse, and
avoiding concentration of dusts.

2. The method as claimed in claim 1, wherein the temperature in the warehouse is kept between +5° C. and +30° C.

3. The mated as claimed in claim 1 or 2, wherein the temperature in the warehouse is measured at points at which the greatest differences can be expected relative to one another, in particular under the roof and/or on the south-facing wall.

4. The method as claimed in one of the preceding claims, wherein heating energy or cooling energy can be introduced via heat exchangers in at least one air circulation system.

5. the method as claimed in one of the preceding claims, wherein the volume of air in the warehouse is circulated continuously 0.4 times per hour via the at least one air circulation system.

6. The method as claimed in one of the preceding claims, wherein the at least one air circulation system supplies air, distributed uniformly under the warehouse ceiling, in order to ensure homogeneous distribution of the oxygen-reduced atmosphere in the warehouse.

7. The method as claimed in one of the preceding claims, wherein the at least one air circulation system sucks in used air uniformly in the floor area, in order to ensure homogeneous distribution of the oxygen-reduced atmosphere in the warehouse.

8. The method as claimed in one of the preceding claims, wherein one portion of the circulating air of the at least one circulating air system can be emitted into the environment.

9. The method as claimed in one of the preceding claims, wherein solvent detectors are arranged in the area close to the floor.

10. The method as claimed in one of the preceding claims, wherein all potential ignition sources are switched off when the proportion by volume of solvent in the atmosphere exceeds a predetermined limit value, in particular 7% of the lower explosion limit.

11. The method as claimed in one of the preceding claims, wherein oxygen detectors are supplied with the warehouse atmosphere to be measured via vertical induction tubes having a number of induction openings which are distributed at different heights.

12. The method as claimed in one of the claims 1 to 12, wherein the surveillance of the proportion by volume of oxygen in the atmosphere takes place at 38 induction sites on three levels in a manner covering all areas.

13. The method as claimed in one of the claims 1 to 12, wherein the monitoring of the proportion by volume of oxygen in the atmosphere is carried out with the help of paramagnetically operating O₂-measurement devices.

14. The method as claimed in claim 13, wherein a number of the O₂-measurement devices can be switched sequentially to an analysis unit.

15. The method as claimed in claim 14, wherein the residence time of an O₂-measurement device on the analyzer is approximately 30 seconds.

16. The method as claimed in one of the claims 1 to 15, wherein an updating of the measurement value occurs every 8 minutes,

17. The method as claimed in one of the claims 1 to 16, wherein a calibration of the analysis units takes place once daily with the help of gas mixtures of a known composition.

18. A fire and explosion-protected high-bay warehouse for hazardous chemical substances and, in particular, for Class AI and B VbF substances, having
at least one device for reducing the proportion by volume of oxygen in the atmosphere of the warehouse by feeding it a barrier gas, in particular nitrogen, preferably at a value of between 12.9 and 13.4% by volume,
at least one monitoring device for monitoring the proportion by volume of oxygen in the atmosphere,
at least one air circulation system,
at least one further monitoring device for monitoring the proportion by volume of solvent in the atmosphere by means of solvent detectors,
at least one cleaning system for removing gaseous substances from the atmosphere in the warehouse, and
filters in at least one of the air circulation systems in order to avoid the concentration of dusts.

19. The fire and explosion-protected warehouse as claimed in claim 18, wherein a nitrogen source and a distribution system are connected to the at least one device for reducing the proportion by volume of oxygen.

20. The fire and explosion-protected warehouse as claimed in claim 19 or 19, wherein a device is provided for setting the temperature in the warehouse between +5° C. and +30° C., in particular heating and/or cooling appliances, which supply or carry away the energies via heat exchangers which are provided in at lest one air circulations system.

21. The fire and explosion-protected warehouse as claimed in one of claims 18 to 12, which has a system for obtaining nitrogen from the air for permanent inertization of the warehouse, which system is connected or can be connected to the at least one air circulation system.

22. The fire and explosion-protected warehouse as claimed in one of claims 18 to 21, wherein all the drives are designed for ex quality, in order to avoid ignition sources.

23. The fire and explosion-protected warehouse as claimed in one of claims 18 to 22, wherein all ignition sources (the drives, sliding lines for the servers) are arranged at a high level, outside the explosion-hazard area, in particular at a height of more than 0.8 m above the floor.

24. The fire and explosion-protected warehouse as claimed in one of claims 18 to 23, wherein temperature probes for temperature measurement are arranged at those points in the warehouse at which the greatest differences relative to one another can be expected, in particular under the roof and/or on the south-facing wall.

25. The fire and explosion-protected warehouse as claimed in one of claims 18 to 24, wherein at least one air circulation system is provided, which allows the volume of air in the warehouse to be circulated continuously 0.4 times per hour.

26. The fire and explosion-protected warehouse as claimed in one of claims 18 to 25, wherein supply lines which are distributed uniformly under the warehouse ceiling are connected to at least one air circulation system.

27. The fire and explosion-protected warehouse as claimed in one of claims 128 to 26, wherein induction channels which are distributed uniformly in the floor area are connected to at least one air circulation system.

28. The fire and explosion-protected warehouse as claimed in one of claims 18 to 27, wherein at least one air circulation system is designed such that a portion of the circulating air can be emitted to the environment.

29. The fire and explosion-protected warehouse as claimed in one of claims 18 to 28, wherein solvent detectors are arranged in the area close to the floor.

30. The fire and explosion-protected warehouse as claimed in one of claims 18 to 29, wherein a device is provided for switching off all potential ignition sources when the proportion by volume of solvent in the atmosphere exceeds a predetermined limit value, in particular 7% of the lower explosion limit.

31. The fire and explosion-protected warehouse as claimed in one of claims 18 to 30, wherein a central control system is provided.

32. The fire and explosion-protected warehouse as claimed in one of claims 18 to 31, wherein filters are arranged in the air circulations system.

33. The fire and explosion-protected warehouse as claimed in one of claims 18 to 32, wherein vertical induction tubes, having two or more induction openings which are distributed at different heights, are provided in order to supply the oxygen detectors.

34. The fire and explosion-protected warehouse as claimed in one of claims 18 to 33, wherein the monitoring device for monitoring the proportion by volume of oxygen in the atmosphere of the high-bay warehouse comprises paramagnetic O₂-measurement devices.

35. The fire and explosion-protected warehouse as claimed in claim 34, wherein at least one analysis unit is provided, which can be connected to a number of O₂-measurement sites and which sequentially analyzes the measurement values of the O₂-measurement sites.

36. The fire and explosion-protected warehouse as claimed in claim 35, wherein numerous analysis units are provided.

37. The fire and explosion-protected warehouse as claimed in claim 36, wherein three analysis units are provided.

38. The fire and explosion-protected warehouse as claimed in claim 36 or 37, wherein each analysis unit can be connected to the same numbered O₂-measurement sites.

39. The fire and explosion-protected warehouse as claimed in one of claims 34 to 38, wherein the induction openings are distributed and arranged over three levels in a manner covering all areas.

40. The fire and explosion-protected warehouse as claimed in one of claims 34 to 39, wherein additional measurement sites are provided in areas of the high-bay warehouse in which the presence of people can be expected.

41. The fire and explosion-protected warehouse as claimed in one of claims 35 to 41, wherein the analysis units are located outside of the high-bay warehouse.

42. The fire and explosion-protected warehouse as claimed in one of claims 35 to 41, wherein one O₂-measurement site of each analysis unit is arranged in such a manner it records the oxygen content in approximately the same location of the entry area of the high-bay warehouse.

43. The fire and explosion-protected warehouse as claimed in one of claims 18 to 42, wherein at least one electrochemically operating O₂-measurement device is located in the area of an air-lock to the high-bay warehouse.

44. The fire and explosion-protected warehouse as claimed in one of claims 12 to 43, wherein at least one device for the detection of carbon monoxide is provided.

45. The fire and explosion-protected warehouse as claimed in claim 44, wherein the device for the detection of carbon monoxide comprises an infrared gas filter correlation sensor.

46. The fire and explosion-protected warehoused as claimed in claim 45, wherein the infrared gas filter correlation sensor exhibits a measurement range of 0 100 ppm of CO.
